(19) United States
(12) Patent Application Publication
(10) Pub. No.: US 2010/0137460 A1
(43) Pub. Date: Jun. 3, 2010

(54) ELECTROCHEMICAL DEVICES CONTAINING ANIONIC-EXCHANGE MEMBRANES AND POLYMERIC IONOMERS

(76) Inventors: Paolo Bert, Como (IT); Francesco Ciardelli, Pisa (IT); Vincenzo Liuzzo, Pisa (IT); Andrea Pucci, Pisa (IT); Marina Ragnoli, Cascina (IT); Alessandro Tampucci, Collesalvetti (IT)

Correspondence Address: ABELMAN, FRAYNE & SCHWAB, 666 THIRD AVENUE, 10TH FLOOR, NEW YORK, NY, 10017, US

(21) Appl. No.: 12/452,369

(22) PCT Filed: Jul. 9, 2008
(86) PCT No.: PCT/IB2008/052763

§ 371 Date: Dec. 23, 2009

(30) Foreign Application Priority Data
Jul. 10, 2007 (IT) FI2007A000152

(51) Int. Cl. C08J 5/20

(52) U.S. Cl. 521/27

(57) ABSTRACT

Electrochemical devices allowing high performances in resistance, thermal stability and conductivity comprising polymeric ionic exchange membranes and ionomers are described.

### FIELD OF THE INVENTION

The present invention refers to electrochemical devices and in particular to those containing ionic polymers as ionomers.

### STATE OF ART

Electrochemical devices are devices in which an electrochemical reaction is used to produce electricity, such devices are for example: fuel cells, electrolytic cells, batteries, electrolysers etc.

In particular, fuel cell may be divided into two systems: “reformer-based” in which the fuel is processed before it is introduced into the fuel cell system or “direct oxidation” in which the fuel is fed directly into the cell without the need for separate internal or external processing. The last system is thought to be a promising power source for electric vehicles and portable electronic devices in coming years.

The major advantage of “direct<oxidation” systems (also named DAFC i.e. Direct Alcohol Fuel Cell) concern the use of liquid fuels, such as methanol, ethanol, ethylene glycol, etc., which have a high volumetric energy density and better energy efficiency; moreover they are more easily stored and transported than gaseous fuels.

In the DAFC, that normally operate at temperature below 80° C. and at ambient pressure, the liquid fuel and oxygen electrochemically are converts into electrical power, heat, carbon dioxide and water. The cell consists of two electrodes, an anode and a cathode, at which the reactions take place, and an electronically non-conductive polymer membrane between the two electrodes. This has three functions: provides ionic contact between the two parts of the cell, prevents electrical contact between anode and cathode, and also ensures that the reagents fed to the electrodes are kept separate. Two different polymer membrane categories can be used in the DAFC systems: proton exchange membranes (PEMs) and alkaline exchange membranes (AEMs).

Direct alcohol fuel cells that use PEMs membranes, such as Nafion® (DuPont), and precious metal catalysts have been extensively studied but the development has been hampered due to several serious problems: slow kinetics at the electrode, alcohol crossover through the membrane via physical diffusion and electro-osmotic proton drag, which causes both fuel loss and potential decrease of the cathode, CO poisoning of the electrodes; high costs of the membrane and catalyst (generally platinum is used).

Particular advantages come from use of AEMs membranes in the DAFC technologies: fast kinetics to both electrodes, possibility to use cheaper non-noble catalysts, depression of alcohol crossover by electro-osmotic drag effect, higher resistance to CO poisoning and reduced costs.

Membranes of similar kind are also employed in electrolytic cells for hydrogen production (GB 2380055). In this case, the membrane acts as a diaphragm between the anode and the cathode compartments thus separating the gases produced during the process and providing highly pure hydrogen nor requiring further purification.

The current technologies of AEMs for DAFC application, show several limits related to the possibility to obtain a reasonable low cost membrane that presents: high ionic conductivity, chemical stability in high-pH media, low permeability to alcohol crossover and good mechanical properties.

AEMs can be separated in two distinct classes: polymer-salt complexes and ionomers. The polymer-salt complexes are blends of polymers containing heteroatoms (generally oxygen or nitrogen) and ionic salts. The principle of ionic conduction within the structure is based on the interaction between polymers-cation and on the mobility of the corresponding anion in the amorphous polymer phase. Several works are reported in literature but the majority focus on applications other than fuel cells.

A composite of KOH with polyethylene oxide (PEO) was proposed by Arof et el. [Solid State Ionics, 156 (2003) 171] as membrane for a zinc-nickel cells.

A blend of poly(sodium acrylate) with tetramethyl ammonium hydroxide was prepared by Sun et al. [Electrochimica Acta, 48 (2003) 1971] and the authors mentioned AEMs as a potential application.

However, the above said membranes generally exhibit poor chemical stability in high-pH media and high ionic conductivity only at extremely high temperatures (100° C. or higher) as a consequence of their high degree of crystallinity. The film-forming properties of these materials are typically lower than necessary. Further, the presence of mobile cations (K⁺, Na⁺) in alkaline fuel cells, in which CO₂ is generated at the electrodes, can produce undesirable carbonate precipitation that block the electrode layers, a major problem with traditional aqueous KOH electrolyte alkaline fuel cells.

By using monomeric ionic unities, as in the anioninic exchange membranes, the problem of the precipitation of carbonate is overcome. In fact, the cationic sites (typically benzyltrimethylammonium based) are covalently linked on the skeleton of the polymer. Said ionomers include polymers constituted by a styrene backbone (for example divinylbenzene/styrene copolymer, divinylbenzene/4-vinyl-pyridine copolymer) presenting quaternary ammonium sites. However, these materials are mechanically brittle and have a poor durability in high-pH media. The lack of stability, common for membranes functionalised with benzyltrialkylammonium ions, is mainly due to the reaction of ammonium ions with OH⁻ anions via two different mechanism: Hoffmann elimination, if β-hydrogens are present in alkyl ammonium ions; methyl and/or ammine direct nucleophillic displacement by hydroxide ions.

Recent studies have demonstrated that the stability of AEMs, in high pH environment, can be increased by means of two different methods: polymer crosslinking using diamine; introduction of alkylene or alkyleneoxymethylene spacer chains between the benzene ring and the quaternary nitrogen.

Varcoe et al. [Chem. Commun., (2006) 1428] recently have synthesized a alkaline membrane based on poly-vinylbenzyl chloride) functionalised with N,N,N′,N′-tetramethylhexane-1,6-diamine hexane and have tested the material as AEMs in a direct methanol fuel cell application.

Membranes for anion exchange applications were prepared by incorporating the ionomer within a polyolefinic matrix. This membranes combining the most desirable properties of the two components: the property of ionic exchange of the ionomer (for example poly-vinylbenzyl chloride or poly-4-vinylpyridine functionalized with quaternary ammonium) and the mechanic properties and the chemical stability of the poly-olefin substrate (normally polypropylene or polyethylene) Another method for the preparation of AEMs membranes is based on the radiation induced graft polymerization of appropriate monomers to polymeric base films. The grafting of vinylbenzyl chloride, using γ-rays, to a partially fluorinated films such as poly(vinylidene fluoride —[CH₂CF₂]ₙ—) and fully fluorinated films such as poly(tetrafluoroethylene-co-hexafluoropropylene —[CF₂CF₂]ₙ[CF(CF₃)CF₂]ₘ—). Danks et al [J. Mater. Chem. 13 (2003) 712] submitted the functionalised polymers to subsequent ammination.

In U.S. Pat. No. 4,828,941 Stenzel et al. disclosed the use of an anion exchanger solid polymer as membrane for methanol fuel cells.

In U.S. Pat. No. 7,081,484 Sugaya et al. disclosed the production of a anion-exchange membrane that is comprised of an ionomer supported in a chemical inert thermoplastic material. The ionomer is constituted of a polymer with a styrene backbone having alkylene or alkyleneoxymethylene spacer chains between the benzene ring and the quaternary nitrogen. The ionic conducting polymer is prepared by adsorption of the monomers on the thermoplastic matrix followed by radical polymerisation “in situ”.

In U.S. Pat. No. 5,643,490 Takahashi et al disclosed the preparation of a polymer electrolyte that is comprised of a polymer having an alkyl quaternary ammonium salt and a salt. The salt is the reaction product of an heterocycle containing a quaternary nitrogen atom and an aluminium halide.

In U.S. Pat. No. 6,183,914 Yao et al. disclosed the production of a polymer electrolite to be used as membrane in alkaline fuel cells. The composition comprises a polymer having units containing a quaternary nitrogen atom, an eterocycle containing a quaternary ammonium and a metal hydroxide.

The development of anionic-exchange membranes operating under alkaline conditions appears clearly a fundamental step for the preparation of high performance electrochemical devices.

### SUMMARY OF THE INVENTION

The present invention allows to overcome the above said problems and makes available electrochemical devices having high performance in resistance, thermal stability, conductivity thanks to new anion exchange membranes having high ionic conductivity, good mechanic properties and a very high stability in a strongly alkaline environment.

### DETAILED DESCRIPTION OF THE INVENTION

The membranes according to the present invention consist of a functionalised inert thermoplastic-elastomeric biphasic matrix, of formula (I):

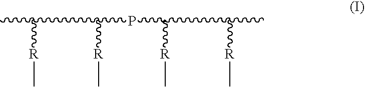

wherein:
P is a chemically stable organic polymer;
and R is a substituent having formula (II)

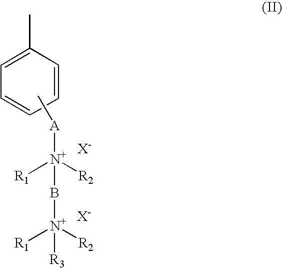

wherein A and B are C₁₋₄ alkyl groups, R₁ and R₂, same or different, are an alkyl or alkylene C₁₋₆ group and R₃ is C₁₋₆ alkyl group functionalized by a further R group as above defined;
X⁻ is an anion.

According to the invention the chemically stable organic polymer is a known thermoplastic elastomer which has weak C—H bonds on the macromolecular backbone.

Such polymers, commercially available, are normally prepared by block copolymers or graft co-polymerization or by compatible mixtures in order to provide the two-phases system as required. A particular example of polymer P, according to the invention is the block polymer poly(styrene)-b-(butadiene)-b-(styrene) (SBS).

According to the invention alkyl groups are methyl, propyl, butyl, pentyl and hexyl; alkenyl groups are preferably polymethylene of formula (CH₂)ₙ with n=2, 3, 4, 5, (ethylene, propylene, butylene, pentylene and hexylene respectively); whereas halide or hydroxyl ions are the preferred anions.

Preferably the group —N⁺R₁R₂—B—N⁺R₁R₂R₃ (that represent the site of anionic exchange) is chosen in the group consisting of: 1,4-diazabicyclo[2.2.2]octane (DABCO), N,N,N′,N′-Tetramethylmetanediamine (TMMDA), N,N,N′,N′-Tetramethylethylenediamine (TMEDA), N,N,N′,N′-Tetramethyl-1,3-propanediamine (TMPDA), N,N,N′,N′-Tetramethyl-1,4-butanediamine (TMBDA), N,N,N′,N′-Tetramethyl-1,6-hexanediamine (TMHDA), N,N,N′,N′-Tetraethyl-1,3-propanediamine (TEPDA).

The R substituents are grafted on polymer P are preferably in amount comprised from 4 to 15% by mol with respect to 100 monomeric units of elastomeric polymer.

The process for the preparation of the membrane according to the invention comprises the functionalization of the polymer by radical grafting of a vinyl monomer of the formula (III):

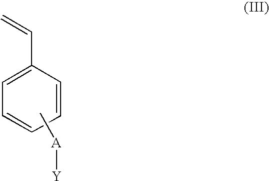

wherein A is as previously defined and Y is a good leaving group for example chlorine, bromine, iodine, a p-toluenesulfonate or a methylsulfonyl group.

The link between the polymer matrix and ionic sites is assured by non hydrolysable covalent bonds.

Thereafter the functionalization with the wanted amine is performed

In detail the method comprises the following steps: the polymer is initially dissolved in an inert-solvent preliminarily distilled under argon or nitrogen atmosphere. Then the monomer of formula (III) is dissolved at room temperature.

The solvent may be totally aliphatic as tetrahydrofuran or dioxane or aromatic as toluene, benzene or xylene.

Preferably, the polymer may be dissolved directly into the monomer (III) if this last is a liquid under the reaction conditions.

After polymer and monomer dissolution, an appropriate amount of a radical initiator is added, (preferably from 0.5 to 1% by mol with respect to the repeating units of the polymer).

The radical initiator which contains weak bonds homolitically broken under mild thermal conditions may be an azocompound as azobisisobutyronitrile (AIBN) or organic peroxides such as benzoyl peroxide (BPO) or dicumyl peroxide. The initiator decomposes with temperature into two active radicals that can give rise to the formation of radicals into the macromolecular backbone. This macroradical results highly reactive towards the functional styrene based monomer promoting its chemical grafting onto the bulk polymer.

The polymer functionalization is performed under an inert gas atmosphere at a temperature higher than 60° C., more preferably in the range between 60 and 100° C., for one hour, more preferably from 1 to 2-3 hours, under mechanical stirring at routes per minute in the range between 100 and 300.

In order to block the progress of the reaction n the established limits it is possible to add to the reagent mixture a radical reaction inhibitor compound such as 3,4-di-tert-butyl-4-hydroxytoluene (BHT), Irganox 1010 or Irganox 1076.

The crude product is obtained after precipitation of the reaction mixture in methanol and it consists on a blend of unreacted polymer, the homopolymer deriving from the radical polymerization of the reactive monomer and the target functionalized polymer.

The homopolymer deriving from the radical polymerization of the styrene based reactive monomer is removed from the crude product by extraction of the solid mixture with a selective solvent which may be dialkyl ether or more preferably acetone for about 6 hours. The obtained product consists of a continuous polymer matrix having covalently attached the reactive functional moieties in a quantity between 4 to 10 mole per 100 repeating units of the polymer depending on the initial amount of the radical initiator. The functionalized polymer has the general structure of the formula (IV):

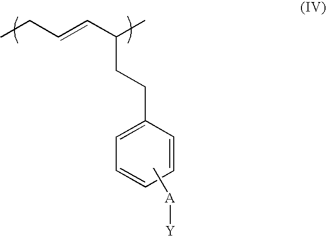

wherein A and Y are as previously defined.

In order to convert the Y group into the anion exchange site, the functionalized polymer is then dissolved into a suitable solvent which can be benzene or toluene in the concentration of 1% by weight. A well soluble tertiary amine, tertiary diamine or more preferably a tertiary cyclic diamine or a mixture, is added to the solution with a molar excess higher than 1.5 by mol with respect to the Y groups of the functionalized polymer. The mixture is then warmed up under stirring at a temperature higher than 50° C., more preferably in the range between 50 and 80° C. for more than 2 hours, more preferably from 2 to 4 hours. The mixture is then placed in an oven at 60° C. for one night in order to complete the amination reaction and to completely remove the solvent providing an anionic conducting polymeric thin film with thickness in the range between 30 to 90 microns.

Alternatively the amination process is performed onto the film of functionalised polymeric. Accordingly, the polymer is dissolved at a concentration of 1% by weight into a suitable solvent which can be dichloromethane or chloroform and the solution poured into a Petri dish. After solvent evaporation a thin film is removed resulting in a sheet of a thickness in the range between 30 to 90 microns. After complete removal of the solvent in the oven at 80° C. during the night, the film is then dipped into a 1 M diamine solution in order to substitute the Y group with an anion exchange group.

The chosen solvent must perfectly solubilize the amine reactant but it has not to dissolve the functionalized polymer film. For example, methanol, acetonitrile or dimethylformamide may be considered. The reaction is carried out at a temperature higher than 50° C., more preferably in the range between 50 and 80° C. for more than 24 hours, more preferably between 24 and 72 hours. The film is then removed from the amine solution, washed repeatedly with fresh amounts of solvent and water and successively dried: in the oven at 80° C. to completely remove the solvent, providing an anionic conducting polymeric thin film with thickness in the range between 30 to 90 microns.

The film is then immersed into a KOH 1M water solution at room temperature for one night and successively placed into an oven at 80° C. for about 12 hours.

In the membranes prepared as above described the of the ammonium salts towards KOH is provided by the high degree of quaternization obtained by using diamines with high steric hindrance. The stability is confirmed by comparing the thermal behaviour and the electric resistance and conductivity of the polymer films before and after treatment with strong alkaline solutions at high temperature.

The high anionic conductivity of the prepared membranes is strictly related to the fuctionalization degree of the elastomeric polymer matrix.

The anionic conductivity has been evaluated in bidistilled water and in alkaline solutions at different KOH concentration.

### Example 1

5 moles of p-chloro-methyl styrene (VBC), 1 mol of monomer units of block-copolymer SBS and 0.3% by weight (in respect of SBS) of benzoyl peroxide were mixed under inert atmosphere and stirred at 80° C. for 3 hours. The mixture was then diluted with chloroform and purified by repeated precipitations in methanol and/or acetone. 1 mol of monomeric units of the obtained polymer was dissolved in chloroform and filmed on Teflon by slow evaporation of the solvent in an atmosphere saturated with chloroform. The film obtained was then immersed into a 1,4-diazabicyclo[2.2.2]octane (Dabco) 1M methanol solution at 60° C. for 72 hours.

TABLE 1
Grafting reaction between SBS and p-chloromethyl styrene (VBC)

| Entry | BPO (% mol)¹ | FD (% mol)² |
|---|---|---|
| SBSF8 | 0.25 | 5.2 |
| SBSF10 | 0.30 | 3.7 |
| SBSF9 | 0.46 | 4.4 |
| SBSF11 | 0.60 | 6.4 |
| SBSF13 | 0.70 | 7.0 |
| SBSF14 | 1.10 | 11.2 |

¹with respect to 100 monomeric units of SBS
²VBC grafting degree with respect to 100 monomeric units of SBS

### Example 2

The films prepared as reported in the example 1 was characterized by electrochemical resistance and impedence measurements in bidistilled water or in KOH 1, 5 and 10 wt. % solutions respectively. The results are reported in Table 2 and 3 and compared with the values obtained in the same conditions for a benchmark membrane by Fumatech GmbH (Germany).

TABLE 2
Electric resistance (in Ω) of anionic-exchange membranes
(film thickness 60 μm)

| Sample | H2O dd | KOH 1% | KOH 5% | KOH 10% |
|---|---|---|---|---|
| SBSF8 | 0.21 | 0.12 | 0.086 | 0.067 |
| SBSF9 | 0.32 | 0.15 | 0.11 | 0.086 |
| SBSF14 | 0.25 | 0.18 | 0.14 | 0.10 |
| FAA (Fumatech) | 0.36 | 0.27 | 0.19 | 0.15 |

TABLE 3
Conductivity values (in S/cm) of the prepared anionic-exchange
membranes (film thickness 60 μm)

| Sample | H2O dd | KOH 1% | KOH 5% | KOH 10% |
|---|---|---|---|---|
| SBSF8 | 0.028 | 0.050 | 0.069 | 0.089 |
| SBSF9 | 0.018 | 0.040 | 0.054 | 0.069 |
| SBSF14 | 0.016 | 0.022 | 0.029 | 0.040 |
| FAA (Fumatech) | 0.019 | 0.026 | 0.037 | 0.047 |

### Example 3

The thermal stability of the prepared membranes was evaluated by differential scanning calorimetry (DSC). The polymer film SBSF9 was analysed before and after immersion into a water solution containing the 5% of KOH and the 10% of ethanol for 1 hour at 80° C. The solution is an example of fuel potentially employed in direct alcohol fuel cells. In addition a thermal-degradation analysis under nitrogen atmosphere was performed in order to evaluate the thermal stability interval of the membranes. All the data were reported in table 4.

TABLE 4
Glass transition temperature (Tg, ° C.) and thermal degradation
temperature (Td, onset, ° C.) of SBSF9

| | Before treatment (° C.) | After treatment (° C.) |
|---|---|---|
| Tg1 | −92 | −92 |
| Tg2 | 72 | 67 |
| Td1 | 244 | 235 |
| Td2 | 411 | 408 |

The glass transition and degradation temperatures before and after thermal treatment in strong alkaline solution appeared similar in values indicating that neither the structure of the polymer backbone nor the reticulation degree, obtained with DABCO, were affected by said treatment.

It should be noted that the technical notes related to the use of anionic-exchange FAA (Fumatech) membrane do not advise the use at temperature higher than 40° C.

1. Membranes for electrochemical devices having formula (I) 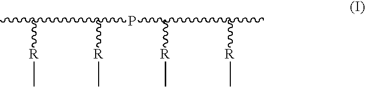
wherein:
P is a chemical stable organic polymer;
and R is a substituent having formula (II) 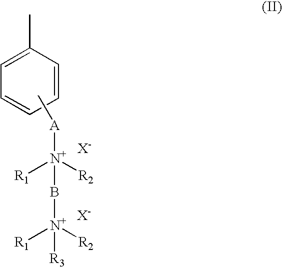
wherein A and B are C₁₋₄ alkyl groups, R₁ and R₂, same or different, are an alkyl or alkylene C₁₋₆ group and R₃ is C₁₋₆ alkyl group functionalized by a further R group as above defined;
X⁻ is an anion.

2. Membranes according to claim 1 in which the chemical stable organic polymer P is a thermoplastic elastomer which has weak C—H bonds on the macromolecular backbone.

3. Membranes according to claim 2 wherein said thermoplastic elastomer is a styrene/aliphatic polymer which contains a ratio between unsaturated and saturated bonds higher than 5%.

4. Membranes according to claim 3 wherein said polymer is poly(styrene)-b-(butadiene)-b-(styrene) SBS.

5. Membranes according to claim 1 wherein said alkyl groups are methyl, propyl, butyl, pentyl and hexyl and said alkylene groups are ethylene, propylene, butylene, pentylene and hexylene; whereas the anions are halides or hydroxyl groups.

6. Membranes according to claim 1 the group —N⁺R₁R₂—B—N⁺R₁R₂R₃ is selected from 1,4-diazabicyclo[2.2.2]octane (DABCO), N,N,N′,N′-Tetramethylmetanediamine (TMMDA), N,N,N′,N′-Tetramethylethylenediamine (TMEDA), N,N,N′,N′-Tetramethyl-1,3-propanediamine (TMPDA), N,N,N′,N′-Tetramethyl-1,4-butanediamine (TMBDA), N,N,N′,N′-Tetramethyl-1,6-hexane diamine (TMHDA), N,N,N′,N′-Tetraethyl-1,3-propanediamine (TEPDA).

7. Membranes according to claim 6 in which the R substituents are grafted in an amount comprised from 4 to 15% by mol with respect to 100 repeating units of the elastomeric polymer.

8. A process for the preparation of membranes having general formula of (I) 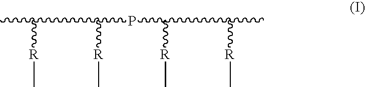
in which the polymer is funtionalised by a radical induced grafting with a vinyl monomer of formula (III) 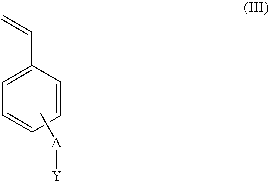
in which A is as previously defined and Y is a good leaving group and the so obtained polymer is then functionalised with the proper amine.

9. A process according to claim 8 in which:
the polymer is firstly dissolved into an inert solvent, or directly in the monomer of formula (III), a radical initiator is then added and in the first case the monomer (III) is added at room temperature;
the crude product obtained has a general formula of (IV) 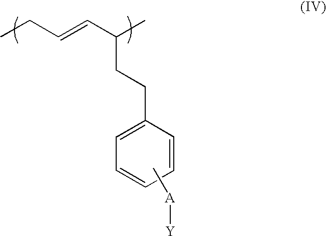
in which A and Y are as previously defined, is dissolved into a proper solvent and the amine added with a molar excess higher than 1.5 by mol with respect to the Y groups of the functionalised polymer;
the mixture is heated under stirring at a temperature higher than 50° C. and successively into an oven at 60° C. overnight in order to complete the amination process and to completely remove the solvent.

10. A process for the preparation of membranes having general formula of (I) 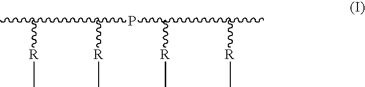
in which:
the functionalised polymer of formula (IV) 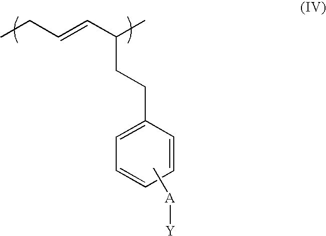
is dissolved in a proper solvent and after solvent evaporation
a film is obtained and then immersed into a diamine solution in order to convert the Y group into the anionic-exchange moiety;
the film obtained is then removed from the amine solution, washed extensively with pure solvent, water and dried in an oven at 80° C. to remove all the volatile substances;
the film is then immersed into a 1 M KOH water solution at room temperature for one night and then dried.

11. A process for employing the membranes according to claim 1 in electrochemical devices.

12. Electrochemical devices comprising a membrane according to claim 1.

13. Devices according to claim 12 selected from the group consisting of: fuel cells, electrolytic cells, batteries and electrolysers.

14. Devices according to claim 13 in which said device is a fuel cell.
